(19) United States
(12) Patent Application Publication
(10) Pub. No.: US 2026/0290164 A1
(43) Pub. Date: Sep. 24, 2026

(54) METHOD AND VEHICLE FOR AUTONOMOUS DRIVING USING END-TO-END MODEL

(71) Applicants: HYUNDAI MOTOR COMPANY, Seocho gu (KR); KIA CORPORATION, Seocho gu (KR)

(72) Inventor: Jin Ho PARK, Gyeonggi do (KR)

(21) Appl. No.: 19/571,623

(22) Filed: Mar. 19, 2026

(30) Foreign Application Priority Data
Mar. 19, 2025 (KR) 10 2025 0035166

(51) Int. Cl. G08G 1/0967; B60W 60/00; G01C 21/36; G06T 7/246; G06V 10/40; G06V 10/80; G06V 10/82; G06V 20/58

(52) U.S. Cl. CPC G08G 1/096725; B60W 60/001; G06T 7/248; B60W 2420/403; B60W 2554/40; B60W 2556/45; G01C 21/36; G06T 2207/20081; G06T 2207/20084; G06T 2207/30241; G06T 2207/30252; G06V 10/40; G06V 10/806; G06V 10/82; G06V 20/584

(57) ABSTRACT

A method and vehicle for autonomous driving using an end-to-end machine-learning model. The method includes generating a geometric feature related to a region and an object around a vehicle based on image data for an environment around the vehicle; generating a trajectory feature of the vehicle by attending to the geometric feature while inputting a trajectory token to a cross-attention model; generating trajectory information of the vehicle based on the trajectory feature and a driving command scheduled in the vehicle; and controlling driving of the vehicle based on the trajectory information.

### CROSS-REFERENCE TO RELATED APPLICATION

Pursuant to 35 U.S.C. § 119(a), this application claims the benefit of an earlier filing date and right of priority to Korean Patent Application No. 10-2025-0035166, filed on Mar. 19, 2025, the disclosure of which is incorporated herein by reference in its entirety.

### TECHNICAL FIELD

The present disclosure generally relates to autonomous driving.

### BACKGROUND

In recent years, vehicles have been implemented with various functions for driving convenience, such as support functions for autonomous driving to perform control of driving operations without driver intervention.

In such scenarios, a vehicle may recognize the surrounding environment obtained by a sensor, obtain various data from inside and outside the vehicle, and identify a situation around the vehicle based on the recognized surrounding environment and the data. The vehicle may establish a control plan for autonomous driving corresponding to the identified situation to control actuators of the vehicle.

### SUMMARY

An aspect of the present disclosure includes a method for autonomous driving using an end-to-end machine-learning model, the method including: generating a geometric feature related to a region and an object around a vehicle based on image data for an environment around the vehicle; generating a trajectory feature of the vehicle by attending to the geometric feature while inputting a trajectory token to a cross-attention model; generating trajectory information of the vehicle based on the trajectory feature and a driving command scheduled in the vehicle; and controlling driving of the vehicle based on the trajectory information.

According to the example of the present disclosure in the method, the generating a geometric feature may include: generating a depth feature based on the image data; and generating the geometric feature based on the depth feature. Also, the depth feature may be generated using a depth encoder of a convolutional neural network (CNN).

According to the example of the present disclosure in the method, the depth encoder may be trained using training image data, ground truth trajectory information, and ground truth image data for synthesis, the depth encoder may be trained using a first loss function between synthetic image data and the ground truth image data for synthesis, and a second loss function between estimated trajectory information inferred from the image data for training and the ground truth trajectory information, and the synthetic image data may be inferred from the training image data, depth information based on the depth feature, and supplemental data for attitude estimation.

According to the example of the present disclosure in the method, the supplementary data may include the estimated trajectory information, attitude information of a sensor unit that obtains the image data is generated based on the estimated trajectory information, and the synthetic image data may be generated based on the image data for training, the depth information, and the attitude information.

According to the example of the present disclosure in the method, the supplemental data may include a plurality of supplemental image data associated with different times from the training image data, attitude information of a sensor unit that obtains the image data may be inferred based on the image data for training and the supplemental image data by an attitude model, and the synthetic image data may be generated based on the image data for training, the depth information, and the attitude information.

According to the example of the present disclosure in the method, the generating a trajectory feature may include generating the trajectory feature by enhancing the trajectory token with attention to the geometric feature by the cross attention model, and the trajectory token may include a plurality of trajectory features for a plurality of times, wherein the plurality of trajectory features are estimated at a first time prior to the plurality of times.

According to the example of the present disclosure in the method, the driving command may include directional movement information scheduled in the vehicle, the driving command may be provided based on directional movement information locally scheduled depending on route guidance information, and the trajectory information may be generated on a two-dimensional space viewed from a predetermined viewpoint of the vehicle.

According to the example of the present disclosure in the method, the method may further includes: generating a semantic feature related to a traffic facility object that provides traffic information for setting a route and driving control based on the image data. Also, the generating a trajectory feature may include generating the trajectory feature by attending to the geometric feature and the semantic feature while inputting the trajectory token to the cross-attention model.

According to the example of the present disclosure in the method, the image data used for generating the semantic feature may include forward image data representing a view in front of the vehicle as a view among multi-view image data.

According to the example of the present disclosure in the method, the generating a semantic feature may include: generating an image feature based on the image data; and generating the semantic feature based on the image feature. The image feature may be generated using an image encoder of a convolutional neural network (CNN).

According to another example the present disclosure, there is provided a vehicle for implementing autonomous driving using an end-to-end model, the vehicle including: a sensor unit obtaining image data of a surrounding environment; a memory storing at least one instruction; and at least one processor executing the at least one instruction stored in the memory. The at least one processor is configured to: generate a geometric feature related to a region and an object around a vehicle based on image data around the vehicle; generate a trajectory feature of the vehicle by attending to the geometric feature while inputting a trajectory token to a cross-attention model; generate trajectory information of the vehicle based on the trajectory feature and a driving command scheduled in the vehicle; and control driving of the vehicle based on the trajectory information.

The features briefly summarized above for this disclosure are only example aspects of the detailed description of the disclosure which follow, and are not intended to limit the scope of the disclosure.

### BRIEF DESCRIPTION OF THE DRAWINGS

The above and other objects, features and advantages of the present disclosure will become more apparent to those of ordinary skill in the art by describing one or more example implementations thereof in detail with reference to the accompanying drawings, in which:

FIG. 1 is a diagram illustrating an example of a vehicle communicating with another device to transmit and receive data.

FIG. 2 is a diagram illustrating an example of a module configuring a vehicle according to an implementation of the present disclosure.

FIG. 3 is a diagram illustrating an example of a module configuring a server according to the present disclosure.

FIG. 4 is a flowchart of an example method for autonomous driving according to another implementation of the present disclosure.

FIG. 5 is a diagram illustrating an example of an end-to-end autonomous driving model according to the present disclosure.

FIG. 6 is a diagram schematically illustrating an example of training of an end-to-end autonomous driving model.

FIG. 7 is a diagram illustrating an example of synthetic image generation.

FIG. 8 is a diagram illustrating another example of synthetic image generation.

### DETAILED DESCRIPTION

Implementations of the present disclosure can provide a method and vehicle for autonomous driving using an end-to-end model constructed with a lightweight structure.

Autonomous driving can be implemented by using a learning model. For example, the learning model may be implemented in a modular technique that implements different sub-models for different tasks, such as perception, decision making or decision, and planning (or control). The learning sub-models for the different tasks undergo respective training, and the trained learning sub-models are combined to deploy the overall autonomous driving model. As an alternative to this modular technique, a learning model can be implemented in an end-to-end technique. An end-to-end model can include a single neural network model that is trained and performs the various tasks, such as recognition, judgment, and planning, in a joint manner. The end-to-end model may be trained with large training datasets of sensor input and associated control output.

In some implementations, the end-to-end model may involve labeling of a large amount of ground truth data for training. Such training can utilize ground truth data that identifies various features based on the recognition of the driving environment and ground truth data related to the vehicle's route. The ground truth data for feature identification may relate to, for example, object detection and map prediction tasks. The ground truth data related to the route may be data related to ego vehicle trajectory (waypoint) prediction.

The route-related ground truth data may use, for example, motion information of the vehicle using a controller area network (CAN) signal or the like, so that an acquisition cost may be relatively low. However, the ground truth data for feature identification typically involves a large amount of cost. As such, in most cases, using a large amount of lidar sensor data increases the burden in terms of cost and training efficiency.

Hereinafter, various example implementations of the present disclosure will be described in detail with reference to the accompanying drawings so that those skilled in the art may easily implement the present disclosure. However, examples of the present disclosure may be implemented in various different ways, and is not limited to the implementations described therein.

According to some implementations of the present disclosure, the end-to-end model can be trained through self-supervised depth estimation, so as to obtain driving environment data for a function of autonomous driving, e.g., a planning task. The training can be performed, for example, using image data and trajectory information on a two-dimensional space. This can improve training efficiency and reduce training cost by reducing the amount of the various types of ground truth data and reducing the large amount of ground truth data.

The effects obtainable in the present disclosure are not limited to the effects mentioned above, and other effects not mentioned will be clearly understood by a person skilled in the art to which the present disclosure belongs from the description below.

In describing various aspects of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an implementation could be termed a second element in another implementation, and, similarly, a second element in an implementation could be termed a first element in another implementation, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed implementations are included in the scope of the present disclosure.

In the present disclosure, elements described in various implementations do not necessarily mean essential elements, and some of them may be optional elements. Therefore, an implementation composed of a subset of elements described in an implementation is also included in the scope of the present disclosure. In addition, implementations including other elements in addition to the elements described in the various implementations are also included in the scope of the present disclosure.

The advantages and features of implementations of the present disclosure and the way of attaining them will become apparent with reference to implementations described below in detail in conjunction with the accompanying drawings. Implementations, however, may be embodied in many different forms and should not be constructed as being limited to example implementations set forth herein. Rather, these implementations are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “”at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, implementations of the present disclosure will be described with reference to the accompanying drawings.

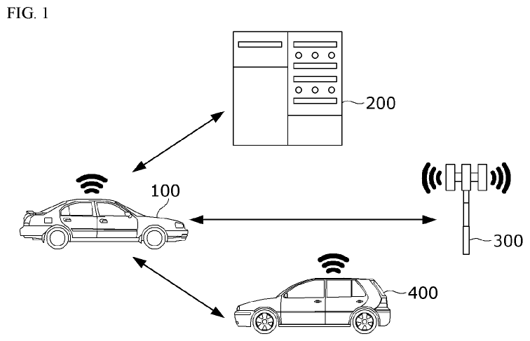

A vehicle that implements autonomous driving using an end-to-end model and a server that supports the vehicle will be described with reference to FIGS. 1 to 3.

FIG. 1 is a diagram illustrating an example of a vehicle communicating with another device to transmit and receive data.

Referring to FIG. 1, a vehicle 100 may be driven on a suitable energy source, such as electric energy or fossil energy. In the case of electric energy, the vehicle 100 may use, for example, a battery driven only by a high-voltage battery or a gas-based fuel cell as an energy source. In addition, the fuel cell may utilize various forms of gas capable of generating electrical energy, and the gas may be filled into the vehicle 100, for example, in a liquefied state. Here, the gas may be, for example, hydrogen. However, it is not limited thereto and various gases may be applied. In the case of fossil energy, the vehicle 100 may be driven based on a fuel, such as gasoline, diesel, or liquefied gas, and may be equipped with an internal combustion engine that drives an actuating unit 116 by combustion of the fuel. The engine may be included in a power source unit 114 in terms of providing a driving rotational force of a wheel. As another example, the vehicle 100 may selectively utilize the energy of a fossil energy-based internal combustion engine and an electric battery to drive the actuating unit 116, which may be a hybrid type of vehicle.

The vehicle 100 may generally refer to a device that is capable of moving. For example, the vehicle 100 can be a ground vehicle driving on the ground, and may be a passenger vehicle or commercial vehicle, a Purpose Built Vehicle (PBV), or the like. The vehicle 100 may be a four-wheeled vehicle, such as a passenger car, an SUV, a small truck, or may be a vehicle with more than four wheels, such as a bus, a large truck, a container transport vehicle, a heavy equipment vehicle, or the like. The vehicle 100 may be a robot in a broad sense, such as a moving means, and the robot may be moved using wheels, tracks, or other moving modules.

The vehicle 100 may be controlled and driven by manual driving or autonomous driving due to the driving of a user. The autonomous driving may be implemented as semi-autonomous driving or fully autonomous driving. The fully autonomous driving may be provided as autonomous movement in which a processor 120 of the vehicle 100 completely controls control without user intervention, even when the driving situation is uncertain. The semi-autonomous driving may be provided as autonomous movement in which driver intervention is required depending on a specific driving situation. The semi-autonomous driving may be implemented such that the processor 120 switches control over to the user while deactivating autonomous driving in the event of the situation, thereby causing the user to perform manual driving. According to the level of autonomous driving defined in the American Society of Automotive Engineers SAE, semi-autonomous driving corresponds to autonomous driving levels 1 to 4, and fully autonomous driving may correspond to level 5.

In some implementations, the vehicle 100 may communicate with other devices, e.g., devices 200, 300 or another vehicle 400. Other devices may include, for example, a server 200 that supports various controls, state management, and driving of the vehicle 100, an ITS device 300 for receiving information from an intelligent transportation system (ITS), various types of user devices, and the like. The server 200 is, for example, an external device operated by a vehicle manufacturer or provided to service a driving support function, and may receive connected data of the vehicle 100 or transmit data necessary for manual and autonomous driving. The server 200 may transmit various information and software modules used for control of the vehicle 100 to the vehicle 100 in response to requests and data transmitted from the vehicle 100 and a user device, to support driving of the vehicle 100 and various services.

The ITS device 300 is, for example, a roadside base station (RSU), and the ITS device 300 may interchange vehicle recognition data, driving control and state data, environment data around the vehicle, map data, and the like through V2I with the vehicle 100 to assist the user's own vehicle driving or support autonomous driving of the vehicle 100. The vehicle 100 may support manual driving or autonomous driving by interchanging the above-listed data through V2V with another vehicle 400.

The vehicle 100 may communicate with other vehicles or other devices based on cellular communication, Wireless Access in Vehicular Environment (WAVE) communication, Dedicated Short Range Communication (DSRC) or near field communication, or other communication methods.

For example, the vehicle 100 may use a communication network such as LTE or 5G, a WiFi communication network, a WAVE communication network, or the like as a cellular communication network for communication with the server 200, the ITS device 300, or the another vehicle 400. As another example, a DSRC or the like used in the vehicle 100 may be used for communication between vehicles. A communication method between the vehicle 100, the server 200, the ITS device 300, the other vehicle 400, and a user device is not limited to the foregoing implementation.

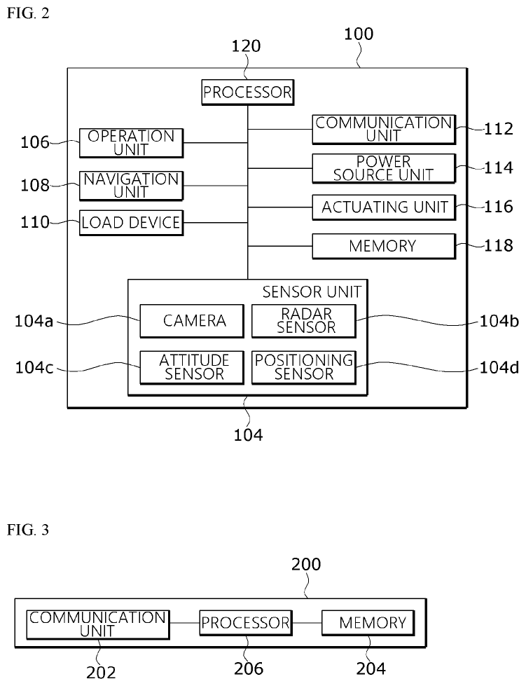

FIG. 2 is a diagram illustrating an example of a module configuring a vehicle according to an implementation of the present disclosure.

The vehicle 100 may include a sensor unit 104, an operation unit 106, a navigation unit 108, a load device 110, and a communication unit 112.

The sensor unit 104 may include various types of sensors for sensing various states and situations occurring in an external surrounding environment, an internal system, a user operation, and a boarding space of the vehicle 100.

For example, the sensor unit 104 may include an externally-oriented camera 104a, a radar sensor 104b, and the like to detect dynamic and static objects existing around the vehicle 100.

The camera 104a may generate image data by detecting an external object as an image during use of the vehicle 100, and transmit the image data to the processor 120. The at least one camera 104a may be mounted on a specific portion of the vehicle 100, such as a front portion, a rear portion, or a lateral portion of the vehicle 100. When a plurality of cameras 104a are mounted on each site, the plurality of cameras 104a may be referred to as a multi-camera in the present disclosure. The image data obtained by the plurality of cameras 104a may be referred to as multi-view image data. Although not shown, the sensor unit 104 may further include an image sensor that faces the interior of the vehicle 100.

The radar sensor 104b may emit radio waves of a specific frequency around the vehicle 100 to generate radar data via radio waves reflected from the external object in order to grasp the presence, relative distance, speed, direction, and the like of the external object. In some implementations, a lidar sensor may be mounted on the vehicle 100. The lidar sensor may generate point cloud data as recognized data of the external object and transmit it to the processor to generate three-dimensional spatial information that identifies at least a shape of the external object.

The sensor unit 104 may include an attitude sensor 104c. The attitude sensor 104c may detect, for example, three-axis states of the vehicle 100, such as yaw, pitch, and roll, and output various attitude states of the vehicle based on the factors described above. The attitude sensor may be configured, for example, as an IMU sensor, a gyro sensor, or the like. The processor 120 may generate attitude data based on the attitude states.

In addition, the sensor unit 104 may include a positioning sensor 104d for confirming the position of the vehicle 100. The positioning sensor 104d is, for example, but not limited to, a GPS sensor or a GNSS sensor.

In addition, the sensor unit 104 may include various other types of sensors, such as a brake sensor and/or a wheel sensor. The brake sensor may detect a braking degree of a brake, and the wheel sensor may detect, for example, a wheel speed, a wheel rotation angle, and a wheel rotation angular speed of the wheel. The present disclosure mainly describes the sensors of the sensor unit 104 referred to in the description of the implementation, and may further include sensors that sense various situations not listed therein.

The operation unit 106 may be configured as a module for a user to manipulate for driving. For example, the operation unit 106 may include a steering wheel for manual driving, an automatic or manual transmission actuator, an accelerator pedal, a brake pedal, a gear transmission, or the like. The operation unit 106 may further include an interface for using, releasing, and selecting a detailed function of the autonomous driving mode requested from the user, so that the user uses the autonomous driving function. The operation unit 106 may be configured with, for example, a hard type interface provided at a predetermined position inside the vehicle 100 or a soft type interface that is touchable on a display in order to receive various requests related to autonomous driving.

The navigation unit 108 may generate route guidance information based on a route request message requested by the user or the processor 120. The route guidance information may be generated to include global route information from a departure point to a destination and local route information in the vicinity of a location where the vehicle 100 drives. The local route information may include a predetermined route to a predetermined range in a driving position and a driving direction to the range. The driving direction is related to lateral control of the vehicle 100 and may be, for example, straight, left, right, etc.

In some implementations, the navigation unit 108 may receive, for example, a user's request via a touchable display, and output route guidance information to the display. In addition, the navigation unit 108 may generate route guidance information by using map information stored in a memory 118 or the server 200.

In order to generate trajectory information in an end-to-end autonomous driving model according to some implementations of the present disclosure, the navigation unit 108 may transmit local route information to the processor 120. The processor 120 may generate a driving command based on the local route information, so that the model uses the driving command. The driving command may include movement information generated based on the local route information. The movement information may relate to, for example, a rough outline of future driving direction. The movement information may be data obtained by predicting the driving direction locally at the driving position based on the route guidance information, specifically the local route information.

The load device 110 can be mounted on the vehicle 100, and may include various types of electrical loads that consumes and converts electrical energy into another form, such as light, heat, or motion. The load device 110 can generally include various types of non-driving electric device that exclude a driving power system such as a wheel driving unit 116. As such, the load device 110 can be an auxiliary device that receives power from the power source unit 114, and may be, for example, an air conditioning system, an indicator lamp system, a lighting system, a seat system, and various devices installed in the vehicle 100.

The communication unit 112 may support communication between the server 200 and the ITS device 300, the adjacent vehicle 400 and the like. The communication unit 112 may include, for example, a module that processes cellular communication, WAVE, DSRC communication, and the like. In the present disclosure, the communication unit 112 may transmit data generated or stored during driving to the server 200 in a signal form, and receive data and a software module transmitted from the server 200 as a specific type of signal. The communication unit 112 may support communication for transmitting or receiving signals related to data, controls, commands, and requests between the components of FIG. 2. The component may be an instrument or module designated by reference numerals 104 to 120 as illustrated in FIG. 2. The communication unit 112 may transmit a signal transmitted between components, that is, a signal related to data, control, command, and request, to a communication bus using, for example, Controller Area Network (CAN) communication, and transmit the signal to a specific component. Data, controls, commands, and requests transmitted in CAN communication may be referred to as CAN data. The communication unit 112 may support communication with an electronic device carried by a passenger inside the vehicle 100. In the present disclosure, the vehicle 100 may transmit and receive data utilized in the method according to the present disclosure to and from the outside through the communication unit 112.

In addition, the vehicle 100 may include a power source unit 114 and an actuating unit 116. The power source unit 114 may generate and supply power and electric power to be used for the driving power system and the non-driving power system, such as the actuating unit 116. The non-driving power system may be, for example, and not limited to, the sensor unit 104, the operation unit 106, the navigation unit 108, the load device 110, the communication unit 112, and the like, and may include various components that implement sensing, interface, communication, and convenience functions except for components directly involved in driving operations.

When the vehicle 100 is driven on an electrical energy basis, the power source unit 114 may be composed of, for example, an electrical battery charged from the outside, or may be composed of a combination of an electrical battery and a fuel cell for charging the battery. In the case of a combination of an electric battery and a fuel cell, the power source unit 114 may include a tank that stores a substance used to generate power of the fuel cell, such as liquefied hydrogen. When the vehicle 100 is driven on a fossil energy basis, the power source unit 114 may be configured as an internal combustion engine. In addition, when the vehicle 100 is of a hybrid type, the power source unit 114 may be provided by a combination of an internal combustion engine and an electric battery.

The actuating unit 116 includes at least one module that implements a driving operation, and may execute the driving operation based on a user request from the operating unit 106 or a signal depending on a request of the processor 120. The signal depending on the request may relate to at least one of a longitudinal control such as acceleration or deceleration, a lateral control such as steering, a gear shift, for example. Here, the gear shift may be processed by a request of a manual driving user using a gear shifter or the processor 120 in autonomous driving.

The actuating unit 116 may include a wheel driving unit (not shown), a mechanical component for implementing a driving operation in the wheel driving unit, and an electronic module to perform a driving operation depending on an instruction of the processor 120 by a user's manual operation or autonomous driving. When the vehicle 100 is operated on an electrical energy basis, it may include an assembly for transmitting the requested driving operation to the wheel driving unit 116. When the vehicle 100 is operated on a fossil energy basis, the actuating unit 116 may include a transmission that transmits power of an internal combustion engine, and a gear module.

The wheel driving unit may include a plurality of wheels, a driving force generation module for generating a driving force and applying it to the wheels or transmitting a driving force, a braking module for decelerating driving of the wheels, and a steering module for realizing lateral control of the wheels. When the vehicle 100 is driven on an electrical energy basis, the driving force generation module may be configured with a motor assembly that generates a driving force based on power output from an electrical battery. The electric-based braking module of the vehicle 100 may further have a regenerative braking function.

Further, the vehicle 100 may include at least one memory 118 and at least one processor 120. The memory 118 may store an application and various data for controlling the vehicle 100, and load the application or read and write data at the request of the processor 120. In implementations of the present disclosure, the memory 118 may store an application and at least one instruction for controlling autonomous driving of the vehicle 100 based on images of the surroundings. The application may be implemented as a learning model for autonomous driving, that is, an end-to-end autonomous driving model. Hereinafter, for convenience of description, the end-to-end autonomous driving model may be abbreviated as end-to-end model. In addition, in the present disclosure, a model constructed by learning may be described interchangeably with terms such as a network, an algorithm, a learning model, and the like.

The end-to-end model is composed of a single neural network model that performs various tasks such as recognition, determination, and planning. The end-to-end module can obtain sensor data from the sensor unit 104 as input, and can generate outputs including trajectory information. As such, the end-to-end model can infer trajectory information for vehicle control based on the sensor data via the single model. Here, the sensor data may be, for example, image data for an environment around the vehicle obtained from the camera 104a. The trajectory information can include at least future prediction route information, and may further include a command for controlling the actuating unit 116.

The end-to-end model may be constructed by training a single model in an integrated manner using sensor input and control output as training data. In some implementations, the single neural network model may include at least one block that performs specific processing in the model. The block may be a component that has trainable parameters to generate a particular output in response to a particular input. The block may be a component such as, for example, an encoder, an attention module, a decoder, a neural network layer, a preprocessor, a postprocessor, or the like. In implementations the present disclosure, details of the end-to-end autonomous driving model will be described later.

In some implementations, the vehicle 100 may receive a trained end-to-end autonomous driving model from the server 200, embed the trained model in the memory 118, and perform various controls based on the model. The memory 118 may hold, in a block of the end-to-end model, other parameters related to the model and data used in the operation of the model. The learned parameters may be, for example, weights, biases, etc., and other parameters may be unique parameters inherent to the model and block, in addition to the learned parameters. The data used for the operation of the model may be, for example, data supporting pre-processing and post-processing, tables, and the like.

The processor 120 may perform overall control of the vehicle 100. The processor 120 may be configured to execute applications and instructions stored in the memory 118. The processor 120 may generate, depending on a driving control request in manual driving and autonomous driving, a signal related to control for a component of the vehicle 100. The component may be at least one of the various components described in FIG. 2. The processor 120 may include, for example, at least one of a Central Processing Unit (CPU), a Graphical Processing Unit (GPU), and a Neural Processing Unit (NPU). The processor 120 may, in another example, function as a controller. The controller includes the processing unit, a cache memory, a bus interface, and the like, and may be, for example, an Electric Control Unit (ECU). The controller is not limited to the above-described example, and may be various control units related to the control of a specific function of the vehicle.

In addition, the processor 120 may generate trajectory information using the end-to-end autonomous driving model, based on image data of an environment around the vehicle, and control driving of the vehicle 100 based on a signal depending on the trajectory information. The driving control may include operating the actuating unit 116 with commands generated by the processor 120 to control the components shown in FIG. 2, such as the actuating unit 116.

The processor 120 may execute various processes related to the end-to-end model according to implementations of the present disclosure. For example, the processor 120 may execute processing of generating one or more features, such as a geometric feature, related to a space and an object around the vehicle, based on image data of the environment around the vehicle.

In addition, the processor 120 may perform a process of generating other features, such as a trajectory feature, of the vehicle by attending to the geometric feature while inputting a trajectory token, e.g., by using an attention module.

In another example, the processor 120 may further execute processing to generate other features, such as a semantic feature, in addition to the geometric feature. For example, the processor 120 may generate, based on the image data, a semantic feature related to a traffic facility object that provides traffic information for setting a route and driving control. The traffic facility object may include a traffic facility that provides at least one of driving flow control, a drivable direction, a drivable area, a speed limit, and driving significance information. The traffic facility object may be, for example, a traffic light, a sign, a marker on a road surface, and the like. When the semantic feature is generated, the processor 120 may generating a trajectory feature by attending to the geometric feature and the semantic feature while inputting the trajectory token.

The processor 120 may execute a process of generating trajectory information of the vehicle 100 based on the trajectory feature and a driving command scheduled by the vehicle 100. The processor 120 may perform processing of controlling driving of the vehicle based on the trajectory information.

The processor 120 is illustrated as being configured as a single processing module, as in FIG. 2, to execute the above-described processing. In another example, the processor 120 may be configured as a plurality of processing modules, and the processing may be distributed and processed in the plurality of modules. As another example, the processor 120 may perform the above-described processing in a distributed manner by collaborating with the server 200.

FIG. 3 is a diagram illustrating an example of a module configuring a server according to the present disclosure.

The server 200 may train or update the end-to-end autonomous driving model based on training data including at least image data, ground truth trajectory information, and ground truth image data for synthesis received from the vehicle 100. The server can transmit the trained model or update information of the model to the vehicle 100. Details of the training of the end-to-end model will be described further below.

The server 200 may include a communication unit 202, a memory 204, and a processor 206. The communication unit 202 may transmit and receive data to and from an external device, support communication with the vehicle 100 in the present disclosure, and exchange data with the vehicle 100.

The memory 204 may store an application and various data for operating the server 200, and load the application or read and write data at the request of the processor 206. In implementations of the present disclosure, the memory 204 may manage the end-to-end model embedded in the vehicle 100. The memory 204 may store parameters of the end-to-end model and store update information due to updated training of the model.

The processor 206 may perform overall control of the server 200. The server 200 may be configured to execute applications and instructions stored in the memory 204. The processor 206 may execute the application to process and respond to the user's request transmitted from the vehicle 100. In connection with the present disclosure, the processor 206 may train or update the end-to-end model to transmit the trained model or update information of the model to the vehicle 100.

In implementations of the present disclosure, the processor 206 is illustrated as being configured as a single processing module. In another example, the processor 206 may be distributed into a plurality of processing modules, and the processing described above may be executed by a distributed processing model.

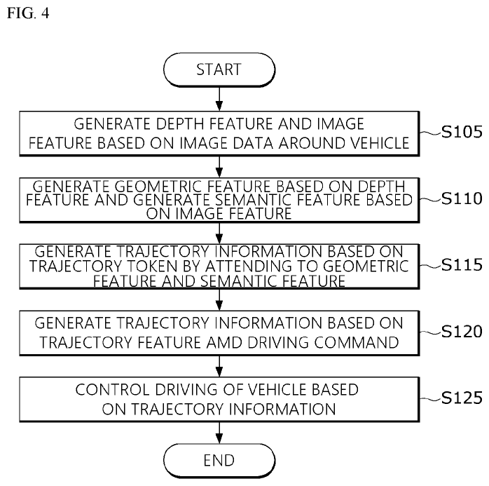

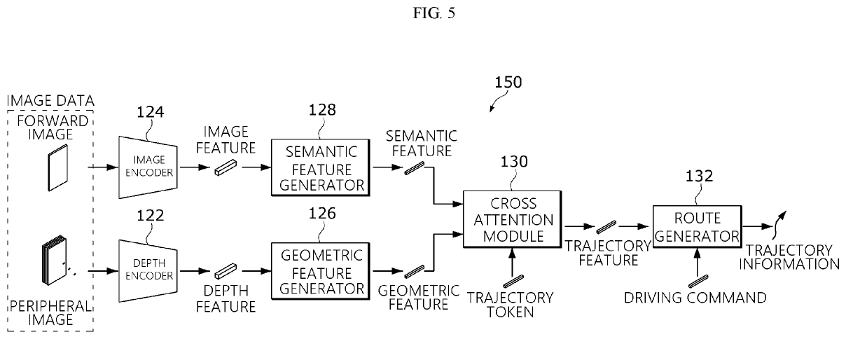

FIGS. 4 and 5 illustrate examples of a method for autonomous driving according to implementations of the present disclosure using an end-to-end autonomous driving model implemented in a vehicle. FIG. 4 is a flowchart of an example method for autonomous driving according to implementations of the present disclosure. FIG. 5 is a diagram illustrating an example of an end-to-end autonomous driving model according to implementations of the present disclosure. In implementations of the present disclosure, the method is performed by the processor 120, but for convenience of description, the processor 120 and the vehicle 100 may be described interchangeably. The method may be performed by an end-to-end autonomous driving model 150 shown in FIG. 5. For convenience of description, the end-to-end autonomous driving model may be abbreviated as the end-to-end model 150.

In S105 of FIG. 4, the processor 120 of the vehicle 100 may generate a depth feature and an image feature based on image data for an environment around the vehicle.

The image data may include multi-view image data obtained from a plurality of cameras 104a oriented in different directions. The multi-view image data may include a forward image including a front view of the vehicle 100 and a peripheral image including a peripheral view excluding the front view of the vehicle 100. The forward image may be a view covering a front range that is within a predetermined angle from the direction of driving of the vehicle 100. The peripheral image may include, for example, a view by a range of at least one of a lateral side and a rear side of the vehicle 100. In another example, the image data may mainly use a forward image, but in the present disclosure, the multi-view image data will be described as an example.

As shown in FIG. 5, the processor 120 may, in response to the input of the multi-view image data, load the trained end-to-end model 150 from the memory 118 and input the multi-view image data to the end-to end model 150. The processor 120 may identify a forward image and a peripheral image based on metadata of the image data. The forward image and the peripheral image are all input to a depth encoder 122, and the forward image may be input to an image encoder 124.

As shown in FIG. 5, the depth encoder 122 may generate a depth feature for all of the multi-view image data based on the image data. The depth feature can be generated for each pixel or can be generated for each area of a predetermined size of the image data, for example, and may be provided to have a reduced dimension compared to the image data.

The depth encoder 122 may use a machine-learning network, for example, a convolutional neural network (CNN). The depth encoder 122 may be constructed, for example, with self-supervised depth estimation. The CNN utilized in the depth encoder 122 may have a convolutional layer and an upsampling layer, but is not limited thereto, and may include layers of various functions. The convolutional layer uses a filter (or kernel), and parameters related to the filter may be learnable parameters.

The depth encoder 122 may generate a depth feature based on time difference information between a plurality of image data. The time difference information may be provided based on the variation of image data due to changes in image acquisition positions (or camera positions) caused by each viewpoint and driving of the multi-view image data. In another example, the depth encoder 122 may be constructed by a supervised learning method. The depth encoder 122 may generate a depth feature from the image data, for example, with reference to visual cues of the image data and parameters of the camera. The visual cues may be texture, shading, viewpoint, etc. The depth encoder 122 by supervised learning also includes a convolutional layer, similar to the encoder above, and may additionally have an upsampling layer. Without being limited thereto, the depth encoder by supervised learning may include layers of various functions.

As shown in FIG. 5, the image encoder 124 may generate an image feature based on forward image data. The forward image includes rich and diverse information for autonomous driving, so that the image encoder 124 may extract an image feature from the forward image for resource mitigation and trajectory generation efficiency. The image encoder 124 may be implemented to detect and distinguish an image feature related to a traffic facility object from image features of the forward image. The traffic facility object may be a traffic facility including, for example, a traffic light, a sign, a marker on a road surface, and the like. The image encoder 124 may use, for example, a convolutional neural network (CNN). The CNN utilized in the image encoder 124 may have a convolutional layer, but is not limited thereto, and may include layers of various functions. The convolutional layer uses a filter (or kernel), and parameters related to the filter may be learnable parameters.

As another example, an image feature may be extracted from both the forward image and the peripheral image of the image encoder 124. The image encoder 124 may distinguish an image feature related to a traffic facility object around the vehicle and output the image feature of the traffic facility object related to the direction of driving.

In S110 of FIG. 4, the processor 120 may generate a geometric feature based on the depth feature, and generate a semantic feature based on the image feature.

As shown in FIG. 5, the processor 120 may input the depth feature to a geometric feature generator 126. The geometric feature generator 126 may process all of the depth features of the multi-view image data. The geometric feature generator 126 may generate a geometric feature represented by a high level of abstraction information provided by compressing the depth feature for use in generating the trajectory feature. In this disclosure, a geometric feature may be referred to as a geometric token. The geometric feature generator 126 may also generate and output a geometric feature in a lower dimension than the depth feature, to match the dimension of other input data in the generation of the trajectory feature.

The depth feature is extracted, for example, for each pixel or area of the image data, but the geometric feature may be generated to have information related to the space and objects around the vehicle. The geometric feature may include spatial information of the image data, geometric structural information of the object, and distance information between the vehicle (or camera 104a) and the object, so as to have a feature representation that abstracts the depth feature.

The geometric feature generator 126 may be implemented as a depth multi-layer perceptron (Depth MLP). Parameters related to each layer, such as weights and biases, may be learnable parameters. The depth multilayer perceptron may infer spatial information, geometrical information of an object, and distance information by compressing the depth feature by inputting the depth feature into a plurality of layers.

The geometric feature generator 126 may use position encoding to distinguish multi-view image data of multiple viewpoints. For example, the position encoding may apply a sinusoidal function reflecting a phase according to each viewpoint to a depth feature of image data having different viewpoints. The location encoding may transmit location information of the image data of each viewpoint to the geometric feature generator 126 to understand the relationship between objects in the image data and the overall context.

In another example, the geometric feature generator 126 may use camera parameters to distinguish multi-view image data of multiple viewpoints. In some implementations, the camera parameters may include an intrinsic parameter and an extrinsic parameter. The geometric feature generator 126 may apply the camera parameters to the depth feature to transform the depth feature.

As shown in the example of FIG. 5, the processor 120 may input the image feature to a semantic feature generator 128. The semantic feature generator 128 may compress the image feature to generate a semantic feature represented by the high level of abstraction information provided, for use in generating a trajectory feature. In this disclosure, the semantic feature may be referred to as a semantic token. The semantic feature generator 128 may also generate and output a semantic feature in a lower dimension than the image feature, to match the dimension of other input data in the generation of a trajectory feature.

The image features may be extracted, for example, for each area of the image data, but the semantic features may include summarized features related to the location of the object of the image data and information provided at the object, such that the semantic features have a feature representation that abstracts the image features. The semantic feature may include an object element extracted such that a characteristic of the class is highlighted, an object position, and a provision element extracted for easy identification of the provision information, in order to estimate a class of each object and provision information of the object in generation of a trajectory feature.

For example, a semantic feature may include an object element and a location that includes a characteristic of a traffic facility object, and a provision element of the traffic facility object. The provision information presented by the traffic facility object as a type of traffic information may include, for example, driving flow control, a drivable direction, a drivable area, a speed limit, and driving significance information. For example, the traffic information may be an indicated color of a traffic light, a driving direction indicated by the traffic light, a speed limit of a sign, a driving direction of a sign, or the like. When the traffic facility object is an arrow and a lane of the roadway marker, the semantic feature may have an object element and an object location as an abstracted feature of the traffic information.

The semantic feature generator 128 may be implemented as an image multilayer perceptron (Image MLP). Parameters related to each layer, such as weights and biases, may be learnable parameters. The image multilayer perceptron may infer semantic features by inputting image features into a plurality of layers to compress the image features.

S105 and S110 are examples of the processor 120 generating an image feature and a semantic feature. In another example, the processor 120 may generate only a depth feature and a geometric feature without generating an image feature and a semantic feature, so as to use only the geometric feature in generating a trajectory feature. In the present disclosure, for convenience of description, implementations are described in which both a geometric feature and a semantic feature are utilized in the generation of a trajectory feature, but implementations are not limited thereto.

In S115, the processor 120 may generate a trajectory feature of the vehicle 100 based on a trajectory token by attending to the geometric feature and the semantic feature.

The trajectory token may be arranged to include a trajectory feature of a future time that is estimated at a particular time. For example, the particular time may be a last acquisition time or an initialization time of the image data. The trajectory token may have trajectory features for each future time separated by discrete intervals. The trajectory token may be, for example, a trajectory feature generated based on image data obtained from a last acquisition time. In another example, the trajectory token may be provided with initial feature data assigned to an initialization time according to a vehicle departure time or a period. The trajectory token according to the examples described above may have the same dimension as the trajectory feature.

To generate the trajectory feature, the processor 120 may use a cross attention module 130, as shown in FIG. 5. The cross attention module 130 may use a geometric feature as a key (K) and value (V), and may use a trajectory token as a query (Q). The cross attention module 130 may primarily generate a trajectory feature by enhancement of the trajectory token by attending information related to the object and space of the geometric feature. The trajectory feature may be output by updating the trajectory token with reference to the geometric feature that includes spatial information, geometric structural information of the object, and distance information. As such, the cross-attention module 130 enables enhancement of the trajectory to interact with other elements in the environment around the vehicle 100.

In some implementations, the cross attention module 130 may use semantic features as the keys and values, and use trajectory features with primarily enhanced trajectory tokens as the queries. The cross-attention module 130 may generate the trajectory feature secondarily by enhancing the primary trajectory feature by attending the information of the semantic feature used to set the route and driving control. The semantic feature may be, for example, compressed traffic information of a traffic facility object located in front on a driving direction basis. By way of specific example, the trajectory feature may be output by updating the primary trajectory feature with reference to the indicated color of the traffic light, the driving direction indicated by the traffic light, a speed limit of the sign, a direction of driving of the sign, and the like.

As such, when the trajectory feature is generated by the attention module 130 based on the trajectory token, the trajectory feature may update (or enhance) the trajectory token of the previously estimated future time by considering information contained in the geometric feature and the semantic feature.

As another example, the cross-attention module 130 may use geometric and semantic features as queries and values, at the same time, to enhance a trajectory token, thereby generating a trajectory feature.

The cross attention module 130 may include an input converter, an attention pulling device with an attention score generator using attention weights, and the like. The attention weight is a learnable parameter, and may include a key weight matrix, a value weight matrix, and a query weight matrix, which are utilized to generate they keys, values, and queries.

In S120, the processor 120 of the vehicle 100 may generate trajectory information of the vehicle 100 based on the trajectory feature and a driving command scheduled in the vehicle 100.

The processor 120 may input the trajectory feature and the driving command to a route generator 132 to infer the trajectory information, as shown in FIG. 5. The route generator 132 may be implemented as a decoder configured with a multilayer perceptron (MLP) for route generation. Parameters related to each layer, such as weights and biases, may be learnable parameters.

The driving command is provided in the generation of trajectory information to determine an approximate future driving direction of the vehicle 100, and the driving command may include a directional control command scheduled in the vehicle. The driving command may be provided based on a directional control command scheduled locally according to route guidance information. The directional control command may be generated based on local route information in the vicinity of a location where the vehicle 100 drives. The driving commands may include commands related to directional control of the vehicle 100, such as, for example, going straight, turning left, turning right, and the like. The route guidance information may be generated, for example, by the navigation unit 108.

As another example, when the navigation unit 108 does not generate the route guidance information because there is no user request or the like, the processor 120 may generate route guidance information including the local predicted route, based on the current location of the vehicle 100 and the map information. For example, when a straight road or a road extending in one direction is continuously located in a forward region from a current position of the vehicle 100 to a predetermined distance ahead, the processor 120 may generate a local predicted route estimated in the straight direction or the one direction. The processor 120 may output a direction control instruction that instructs driving in one direction based on the local prediction route, and generate a driving command accordingly. As another example, when the navigation unit 108 does not generate route guidance information, the processor 120 may generate route guidance information including a local predicted route based on an operation requested by the user or the processor 120 to the operation unit 106, for example, an operation of a direction indicator light. The processor 120 may output the directional control command based on the local predicted route depending on the operation, and generate a driving command accordingly.

The processor 120 may generate trajectory information on a two-dimensional space viewed from a predetermined viewpoint of the vehicle 100. The two-dimensional space may be, for example, a space having substantially the same scale as the image data obtained in two dimensions. For example, the predetermined viewpoint may be designated to have a view viewed in the driving direction of the vehicle. The predetermined viewpoint may be set to have a view viewed from the forward image data among the multi-view image data. In some implementations, the trajectory information may be generated using coarse geometric inference for the two-dimensional image data in a manner similar to the recognition of the surrounding environment in human driving, without elaborately constructing the recognition result of the two-dimensional image data into a three-dimensional space. This can improve efficiency and computational load, enabling a lightweight model.

The trajectory information may include a predicted journey route of the vehicle 100 to drive to a future time, for example, a future N time point with a discrete interval. The trajectory information may be represented in various formats such as, for example, routepoints, trajectories, motion vectors, motion control, and the like.

In S125, the processor 120 of the vehicle 100 may control the driving of the vehicle 100 based on the trajectory information.

The processor 120 may generate commands for controlling the actuating unit 116 based on the trajectory information. The commands for controlling the actuating unit 116 may include, for example, a longitudinal control command and a lateral control command. The longitudinal control command may be, for example, a control command relating to acceleration and deceleration, and the lateral control command may be a control command relating, for example, to steering. The processor 120 generates a signal according to the longitudinal control command and the lateral control command and transmits it to the actuating unit 116, and the actuating unit 116 may be controlled according to the signal.

According to implementations of the present disclosure, the end-to-end autonomous driving model 150 can be implemented in a lightweight structure, using the depth encoder 122 and a small number of cross-attention modules 130, without utilizing a large number of transformer structures. Accordingly, a relatively small amount of computation and capacity can be utilized in the generation of the trajectory route, thereby reducing the resource burden on the processor 120, the memory 118, and the like.

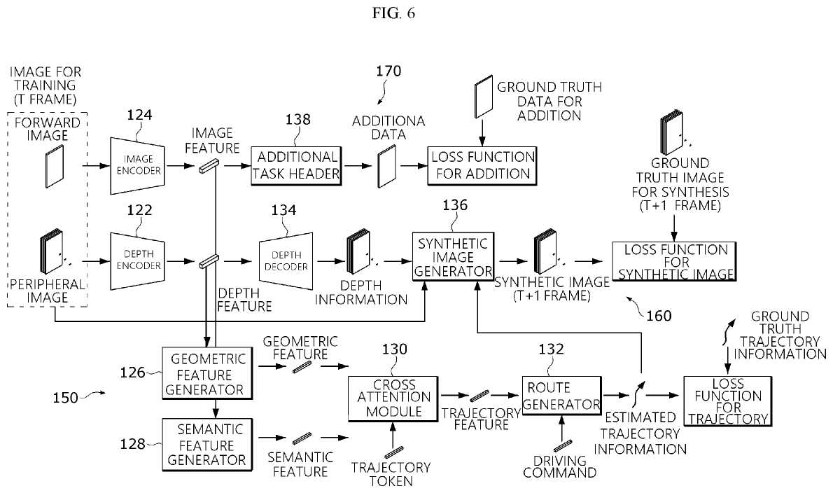

FIG. 6 illustrates an example of a training process of an end-to-end autonomous driving model according to implementations of the present disclosure. Training of the end-to-end model 150 in some implementations of the present disclosure include an image encoder 124 and a semantic feature generator 128. In other implementations, an image encoder 124 and a semantic feature generator 128 are omitted, in which case training of the model 150 can be performed on the network structure with the omitted components excluded.

The training of the end-to-end model 150 can be performed, for example, by the processor 206 of the server 200. In such scenarios, various training data for training may be obtained from the memory 204 of the server 200 and the communication unit 202 of the server 200 in communication with other external devices. Although examples are described herein of the processor 206 of the server 200 performing training of the model 150, implementations are not limited thereto.

The training of the end-to-end model 150 may be performed to train various components, such as the depth encoder 122, the geometric feature generator 126, the semantic feature generator 128, the cross-attention module 130, the route generator 132. The structure of each component is substantially the same as that described in FIG. 4 and FIG. 5, and a detailed description thereof will be omitted. In some implementations, the training of the model 150 may be performed, for example, to train the image encoder 124. In another example, the image encoder 124 may be coupled to the end-to-end model 150 without training. The implementations described herein is illustrated as including training of the image encoder 124 in the model 150.

As shown in FIG. 6, the processor 206 of the server 200 may utilize depth training network 160 to train the depth encoder 122. As such, the server 200 may add the depth training network 160 to the depth encoder 122 in order to train depth encoder 122.

In some implementations, the depth training network 160 may include a depth decoder 134 and a synthetic image generator 136. The depth decoder 134 can generate (reconstruct) depth information based on the depth feature that was generated by the depth encoder 122 from image data for training, which can include multi-view image data. The depth information may be reconstructed to have depth data for each pixel or for each area of a predetermined size of the image data, for example. The depth decoder 134 is configured to have, for example, multiple layers, an upsampling layer, and learnable parameters applied to the layers, but not limited to the above-described matters,.

The synthetic image generator 136 can infer and generate synthetic image data from the image data for training, the depth information, and the supplementary data for attitude estimation. In some implementations, the synthetic image data may be virtual multi-view image data estimated after a frame time of the image data for training. For example, when the image data for training is a frame image at time T, the synthetic image data may be a frame image at time T+1. The supplemental data may be used to generate attitude information that is referenced at the output of the synthetic image data. The attitude information may include data related to the positions and shooting directions of a plurality of cameras 104a that change in time series during driving.

The supplemental data may be estimated trajectory information output from the route generator 132 in training of the end-to-end model 150, or a plurality of supplemental image data having a different time than the image data for training.

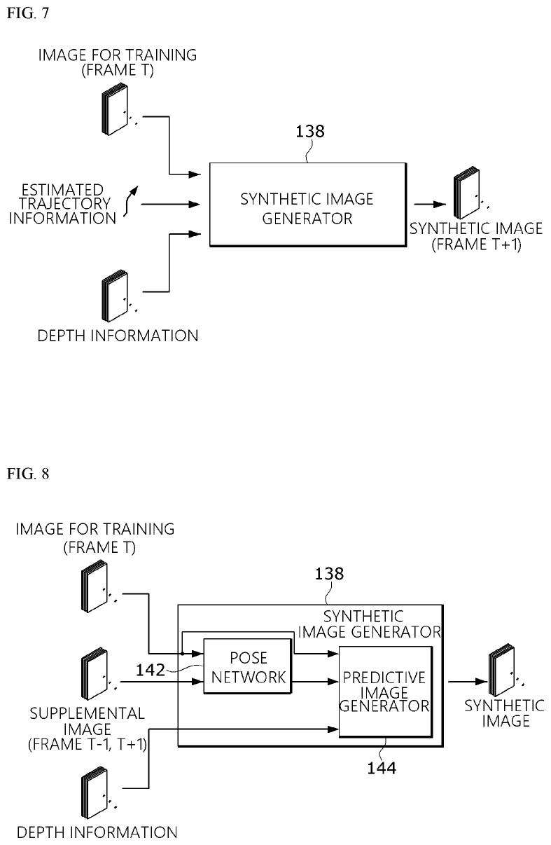

FIG. 7 is a diagram illustrating an example of synthetic image generation. As illustrated in FIG. 7, when the supplemental data uses the estimated trajectory information, the synthetic image generator 136 may convert the estimated trajectory information inferred from the image data for training into two-dimensional attitude information for the plurality of cameras 104a. FIG. 7 is a diagram illustrating an example of synthetic image generation.

The two-dimensional attitude information may be generated, for example, as a coordinate change value in a two-dimensional space similar to the space used in the image data for training. The coordinate transformation value may be described, as a specific example, as dx, dy in a two-dimensional space. With reference to FIG. 6, generation of a predictive image that generates synthetic image data based on image data for training, depth information, and attitude information is learned in training of the end-to-end model 150, but generation of attitude information may not be learned. The above-described generation of the synthetic image data describes a method of synthesizing an image in time to generate an image of a subsequent frame. In addition, the generation of the synthetic image data may further include synthesizing the images spatially, so as to synthesize images between respective image data of a plurality of viewpoints having the same spatial time. In some implementations, synthesis of the spatial image may utilize extrinsic calibration information between the plurality of cameras 104a. For example, when the synthetic image generator 136 identifies that there is an overlapping region between image data for training having different viewpoints at the same time, the synthetic image generator may generate an image of the overlapping area of the image data for training of the different viewpoints by using the pixel value of the overlapping area in the image data for training in one viewpoint. The generation of the prediction image can utilize a deep learning network structure with learnable parameters, but is not limited thereto.

FIG. 8 is a diagram illustrating another example of synthetic image generation. As illustrated in FIG. 8, when the supplemental data uses supplemental image data, the synthetic image generator 136 may include a pose network 142 and a predictive image generator 144.

The pose network 142 may generate two-dimensional attitude information for the plurality of cameras 104a based on changes between image data for training and supplemental image data having the same viewpoint. The supplemental image data may be multi-view image data having the same viewpoint as the image data for training. When the image data for training is an image of a T frame, the supplementary image data may include, for example, at least one of images of a T−1 frame or a T+1 frame. With reference to FIG. 7, the pose network 142 and the predictive image generator 144 used to generate synthetic image data based on image data for training, depth information, and attitude information may be learned in the training of the end-to-end model 150. The above-described generation of the synthetic image data describes a method of synthesizing an image in time to generate an image of a subsequent frame. In addition, the generation of the synthetic image data may further include synthesizing the images spatially, so as to synthesize images between respective image data of a plurality of viewpoints having the same spatial time. The synthesis of the spatial image may be substantially the same as that described in FIG. 6.

To summarize the example of learning of depth encoder 122 illustrated in FIGS. 6-8, the depth encoder 122 is connected to depth training network 160 in the training of end-to-end model 150 and is trained with self-supervised depth estimation, and may be separated from depth training network 160 after completion of the learning. In the self-map depth estimation, the depth encoder 122 and the depth training network 160 may all be trained by generating a synthetic image based on the depth information and the attitude information estimated by the depth encoder 121 and the depth decoder 134 and using a loss function between the synthetic image and ground truth image for synthesis. As shown in FIG. 5, the depth encoder 122 may be separate from the depth training network 160 to construct components of the learned end-to-end model 150.

Referring again to FIG. 6, the processor 206 of the server 200 may use an image training network 170 to train the image encoder 124. The server 200 may add the image training network 170 to the image encoder 124 to train the image encoder 124.

In some implementations, the depth training network 160 may include an additional task header 138. The additional task header 138 may generate additional data based on image features generated from forward image data among image data for training having multi-view image data. The additional task header 138 may be an inference component that performs a particular task. The additional task header 138 may be trained, for example, with forward image data for training, or may be built into a task that detects traffic facility objects, such as traffic lights, signs, etc., to provide traffic information. In addition, in order to easily obtain ground truth data for addition, the additional task header 138 and the image encoder 124 may be trained using ground truth data for addition that is mainly obtained as an image. The ground truth data for addition may be, for example, an image including a traffic identification object. Tasks include, for example, but are not limited to, at least one of object detection or semantic segmentation. The additional task header 138 may output an additional task that estimates a class and location of an object that includes a traffic facility object.

Referring again to FIG. 6, the processor 120 of the server 200 may train the end-to-end autonomous driving model 150, the depth training network 160 coupled to the depth encoder 122, and the image training network 170 coupled to the image encoder 124 by using the image data for training, the ground truth trajectory information, the ground truth image data for synthesis, and the ground truth data for addition as training data.

The ground truth trajectory information may be trajectory information suitably applied to the real environment of the image data for training. The ground truth trajectory information may include a trajectory of the vehicle 100 provided on a two-dimensional space viewed from a predetermined viewpoint of the vehicle 100, so as to have the same state as the estimated trajectory information. For example, the predetermined viewpoint may be designated to have a view in a driving direction of the vehicle. Specifically, the predetermined viewpoint may be set to have a view from forward image data among multi-view image data. The ground truth trajectory information may include, for example, a trajectory derived from a change value of the attitude sensor 104c, a trajectory derived from a change value of a positioning sensor 104d, or a trajectory derived from components illustrated in FIG. 2, for example, CAN signals related to driving control between the processor 120 and the actuating unit 116. Accordingly, the ground truth trajectory information may be easily obtained or generated as compared with the three-dimensional trajectory.

The ground truth image data for synthesis may be multi-view image data subsequent to the image data for training. In some implementations, the ground truth image data for synthesis may be real image data obtained at positions and directions of the plurality of cameras 104a that vary due to driving after the acquisition time of the image data for training. For example, when the image data for training is a T-frame image, the ground truth image data for synthesis may be a T+1 frame image.

In some implementations, the ground truth data may include information related to a class and location of a traffic facility object included in the image data for training. For example, the ground truth data for addition may include a class and location provided in at least one of object detection or semantic segmentation.

The server 200 may input the image data for training having the multi-view image data to the depth encoder 122 and the image encoder 124, and output estimated trajectory information. The estimated trajectory information may be output using the geometric feature generator 126, the semantic feature generator 128, the cross attention module 130, the route generator 132. The input/output data, the information, and the functions of the components described above are substantially the same as those in FIGS. 4 and 5, and a detailed description thereof will be omitted.

The server 200 may control the depth decoder 134 to input a depth feature of the depth encoder 122 to the depth decoder 134 to output depth information. The server 200 may control the synthetic image generator 136 to input the depth information, the image data for training, and the supplemental data to the synthetic image generator 136 to output the synthetic image data. The supplemental data may be estimated trajectory information or supplemental image data. When the supplemental data is estimated trajectory information, the server 200 may generate attitude information based on the estimated trajectory information by using the synthetic image generator 136 illustrated in FIG. 7, and output the synthetic image data based on the depth information, the image data for training, and the attitude information. When the supplemental data is supplemental image data, the server 200 may generate attitude information based on the image data for training and the supplemental image data by using the synthetic image generator 136 illustrated in FIG. 8, and output the synthetic image data based on the depth information, the image data for training, and the attitude information.

The server 200 may train the depth encoder 122, the depth decoder 134, the geometric feature generator 126, the semantic feature generator 128, the cross attention module 130, and the route generator 132 using a loss function for trajectory, a loss function for synthetic image, and a loss function for addition. The trained element may be, for example, a learnable parameter in the above-described components of the end-to-end model 150. Here, for convenience of description, the loss function may be abbreviated as loss. The loss for trajectory may be a loss function based on a difference between the estimated trajectory information and the ground truth trajectory information. The loss for synthetic image may be a loss function based on a difference between the synthetic image data and the ground truth image data for synthesis. The loss for addition may be a loss function based on a difference between the additive data and the correct data for addition.

Further, the server 200 may train the components of the depth training network 160, e.g., the depth decoder 134 and the composite image generator 136, using the loss for trajectory, the loss for synthetic image, and the loss for addition. The server 200 may use the losses to train the additional task header 138 of the image training network 170. The loss for trajectory, loss for synthetic image, and loss for loss may be combined linearly to construct a total loss function. The processor 206 of the server 200 may train the end-to-end model 150, the depth training network 160, and the image training network 170 until the value of the total loss function is below a certain threshold or converges to a certain value.

After the training is completed, the processor 206 may separate the depth training network 160 and the image training network 170 from the end-to-end model 150, and construct the end-to end model 150 for deployment. The server 200 may control the communication unit 202 to distribute the trained end-to-end model 150 to the vehicle 100.

According to implementations of the present disclosure, for the end-to-end model 150 to obtain driving environment data for a function of autonomous driving, for example, a planning task, the model is trained by self-supervised depth estimation mainly using image data and trajectory information on a two-dimensional space. This can have the effect of improving training efficiency and reducing training cost, reducing the need for various types of ground truth data and a large amount of ground truth data.

According to implementations of the present disclosure, a method and vehicle for autonomous driving can use an end-to-end model constructed with a lightweight structure.

In addition, for the end-to-end model to obtain the driving environment data for the function of autonomous driving, for example, a planning task, the model can be trained by self-supervised depth estimation. This can have the technical benefit of improving training efficiency and reducing training cost without a large amount of ground truth data.

The effects obtainable in implementations of the present disclosure are not limited to the effects mentioned above, and other effects not mentioned will be clearly understood by a person skilled in the art to which the present disclosure belongs from the description below.

Effects obtained in the present disclosure are not limited to the above-mentioned effects, and other effects not mentioned above may be clearly understood by those skilled in the art from the following description.

While the example methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various implementations of the present disclosure are not a list of all possible combinations and are intended to describe representative aspects of the present disclosure, and the matters described in the various implementations may be applied independently or in combination of two or more.

In addition, various implementations of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various implementations to be executed on an apparatus or a computer, a non-transitory computer-readable medium having such software or commands stored thereon and executable on the apparatus or the computer.

What is claimed is:

1. A method of autonomous driving using an end-to-end machine learning model, the method comprising:
obtaining, from at least one sensor unit, image data for an environment around a vehicle;
processing the image data with at least one machine-learning network and generating a geometric feature related to a region and an object around the vehicle;
processing, with a cross-attention model, the geometric feature and a trajectory token obtained from the image data, and generating a trajectory feature of the vehicle by attending to the geometric feature while inputting the trajectory token;
processing, with a first multilayer perceptron, the trajectory feature and a driving command scheduled for the vehicle, and generating planned trajectory information for the vehicle; and
controlling driving of the vehicle based on the planned trajectory information.

2. The method of claim 1, wherein the generating of the geometric feature comprises:
processing the image data with a depth encoder of a convolutional neural network (CNN) to generate a depth feature; and
processing the depth feature with a second multilayer perceptron to generate the geometric feature.

3. The method of claim 2,
wherein the depth encoder is trained using at least training image data, ground truth trajectory information, and ground truth image data for synthesis,
wherein the depth encoder is trained using at least (i) a first loss function between synthetic image data and the ground truth image data for synthesis, and (ii) a second loss function between estimated trajectory information inferred from the image data for training and the ground truth trajectory information, and
wherein the synthetic image data is inferred from (i) the image data for training, (ii) depth information based on the depth feature, and (iii) supplemental data for attitude estimation.

4. The method of claim 3,
wherein the supplemental data comprises the estimated trajectory information,
wherein attitude information of the at least one sensor unit that obtains the image data is generated based on the estimated trajectory information, and
wherein the synthetic image data is generated based on the training image data, the depth information, and the attitude information.

5. The method of claim 3,
wherein the supplemental data comprises a plurality of supplemental image data associated with different times from the training image data,
wherein attitude information of the at least one sensor unit that obtains the image data is inferred based on the image data for training and the supplemental image data by an attitude model, and
wherein the synthetic image data is generated based on the image data for training, the depth information, and the attitude information.

6. The method of claim 1, wherein the generating of the trajectory feature comprises:
generating the trajectory feature by enhancing the trajectory token with attention to the geometric feature by the cross-attention model, and
wherein the trajectory token comprises a plurality of trajectory features for a plurality of times, wherein the plurality of trajectory features are estimated at a first time earlier than the plurality of times.

7. The method of claim 1,
wherein the driving command comprises directional movement information scheduled for the vehicle,
wherein the driving command is provided based on the directional movement information locally scheduled depending on route guidance information, and
wherein the trajectory information is generated on a two-dimensional space viewed from a predetermined viewpoint of the vehicle.

8. The method of claim 1, further comprising:
generating a semantic feature related to a traffic facility object that provides traffic information for determining a route and driving control based on the image data,
wherein the generating of the trajectory feature comprises generating the trajectory feature by attending to the geometric feature and the semantic feature while inputting the trajectory token to the cross-attention model.

9. The method of claim 8,
wherein the image data used for generating the semantic feature comprises forward image data representing a view in front of the vehicle as a view among multi-view image data.

10. The method of claim 8, wherein the generating of the semantic feature comprises:
processing the image data with an image encoder of a convolutional neural network (CNN) to generate an image feature; and
processing the image feature with a third multilayer perceptron to generate the semantic feature.

11. A vehicle configured to implement autonomous driving using an end-to-end machine learning model, the vehicle comprising:
at least one sensor unit configured to obtain image data of an environment around the vehicle;
at least one processor; and
at least one memory storing at least one instruction that, based on being executed by the at least one processor, perform operations comprising:
obtaining, from at least one sensor unit, image data for an environment around a vehicle;
processing the image data with at least one machine-learning network and generating a geometric feature related to a region and an object around a vehicle;
processing, with a cross-attention model, the geometric feature and a trajectory token obtained from the image data, and generating a trajectory feature of the vehicle by attending to the geometric feature while inputting the trajectory token;
processing, with a first multilayer perceptron, the trajectory feature and a driving command scheduled for the vehicle, and generating planned trajectory information for the vehicle; and
control driving of the vehicle based on the planned trajectory information.

12. The vehicle of claim 11,
wherein the generating of the geometric feature comprises:
processing the image data with a depth encoder of a convolutional neural network (CNN) to generate a depth feature; and
processing the depth feature with a second multilayer perceptron to generate the geometric feature.

13. The vehicle of claim 12,
wherein the depth encoder is trained using at least training image data, ground truth trajectory information, and ground truth image data for synthesis,
wherein the depth encoder is trained using at least (i) a first loss function between synthetic image data and the ground truth image data for synthesis, and (ii) a second loss function between estimated trajectory information inferred from the image data for training and the ground truth trajectory information, and
wherein the synthetic image data is inferred from (i) the image data for training, (ii) depth information based on the depth feature, and (iii) supplemental data for attitude estimation.

14. The vehicle of claim 13,
wherein the supplemental data comprises the estimated trajectory information,
wherein attitude information of the at least one sensor unit that obtains the image data is generated based on the estimated trajectory information, and
wherein the synthetic image data is generated based on the training image data, the depth information, and the attitude information.

15. The vehicle of claim 13,
wherein the supplemental data comprises a plurality of supplemental image data associated with different times from the training image data,
wherein attitude information of the at least one sensor unit that obtains the image data is inferred based on the image data for training and the supplemental image data by an attitude model, and
wherein the synthetic image data is generated based on the image data for training, the depth information, and the attitude information.

16. The vehicle of claim 11, wherein the generating of the trajectory feature comprises:
generating the trajectory feature by enhancing the trajectory token with attention to the geometric feature by the cross-attention model, and
wherein the trajectory token comprises a plurality of trajectory features for a plurality of times, wherein the plurality of trajectory features are estimated at a first time earlier than the plurality of times.

17. The vehicle of claim 11,
wherein the driving command comprises directional movement information scheduled for the vehicle,
wherein the driving command is provided based on the directional movement information locally scheduled depending on route guidance information, and
wherein the trajectory information is generated on a two-dimensional space viewed from a predetermined viewpoint of the vehicle.

18. The vehicle of claim 11, wherein the operations further comprise:
generating a semantic feature related to a traffic facility object that provides traffic information for determining a route and driving control based on the image data,
wherein the generating of the trajectory feature comprises generating the trajectory feature by attending to the geometric feature and the semantic feature while inputting the trajectory token to the cross-attention model.

19. The vehicle of claim 18,
wherein the image data used for generating the semantic feature comprises forward image data representing a view in front of the vehicle as a view among multi-view image data.

20. The vehicle of claim 18, wherein the generating of the semantic feature comprises:
processing the image data with an image encoder of a convolutional neural network (CNN) to generate an image feature; and
processing the image feature with a third multilayer perceptron to generate the semantic feature.
